(19) United States
(12) Patent Application Publication
(10) Pub. No.: US 2004/0249078 A1
(43) Pub. Date: Dec. 9, 2004

(54) Foam catalyst systems

(75) Inventors: Mary C. Bogdan, Buffalo, NY (US); Leslie Bement, Buffalo, NY (US)

Correspondence Address: SYNNESTVEDT & LECHNER, LLP, 2600 ARAMARK TOWER, 1101 MARKET STREET, PHILADELPHIA, PA, 191072950

(73) Assignee: Honeywell International, Inc., Morristown, NJ

(21) Appl. No.: 10/454,554

(22) Filed: Jun. 4, 2003

(51) Int. Cl. C08J 9/00; C08L 75/00; C08F 8/30

(52) U.S. Cl. 525/125

(57) ABSTRACT

The present invention provides methods of producing polyurethane and polyisocyanurate foams comprising reacting and foaming a mixture of ingredients that react to form a polyurethane or polyisocyanurate foam in the presence of a catalyst solution comprising a catalyst solvent and about 60 wt % or less, based on the total weight of the catalyst solution, of alkali metal salt. Also provided are foams produced via the methods of the present invention.

### FIELD OF INVENTION

The present invention relates to improved foam catalyst systems, to foamable premixes containing such systems, to methods of making foamable and foamed compositions, and to foams made using such catalysts, premixes, systems or methods.

### BACKGROUND OF THE INVENTION

A variety of methods of producing polyurethane and polyisocyanurate foams are known. Many of such procedures involve forming a foam pre-mix comprising one or more reactants, such as isocyanate and polyol, a blowing agent and a foam catalyst. The premix is then processed according to known techniques to produce the desired foam.

In many cases, a potassium salt dissolved or otherwise carried in a polar solvent is the catalyst system used to produce polyurethane and polyisocyanurate foams via conventional methods. For example, “Dabco K-15” is catalyst system comprising 75 wt % of 2-ethyl hexanoic potassium salt and 25 wt % diethylene glycol available from Air Products. This system has been used with some success in the production of certain polyurethane and polyisocyanurate foams.

### DESCRIPTION OF THE INVENTION AND PREFERRED EMBODIMENTS

Applicant has discovered that the potassium salt catalyst systems that have heretofore been used possess serious problems and disadvantages. More particularly, applicant has discovered that prior potassium based catalyst systems are not practical for use in the production of foams containing certain highly desirable, environmentally friendly blowing agents. For example, the assignee of the present application has developed a number of methods for producing foams using relatively environmentally friendly hydrofluorocarbons (“HFCs”) and/or hydrochlorofluorocarbons (“HCFCs”) as blowing agents. Many of these preferred blowing agents have a relatively low boiling point, that is, a normal boiling point of about 70? F (21.1? C) or less. Applicant has discovered that it is not practically feasible to use conventional potassium catalyst systems, such as Dabco K-15, in certain foam premixes containing low boiling blowing agents. More particularly, applicant has discovered that the introduction of such prior catalysts into a composition containing low boiling point blowing agents frequently results in immediate and vigorous frothing of the composition. Such frothing renders the premix composition essentially useless for the effective production of foam. Furthermore, this problem raises serious questions about the stability of a premix composition which contains such a combination.

Accordingly, applicant has recognized a need for catalyst systems and associated methods for effectively and efficiently producing polyisocyanurate and polyurethane foams using alkali metal catalysts systems which can be used with a wider variety of HFC and HCFC blowing agents, and particularly low boiling blowing agents, while avoiding the disadvantages associated with prior catalyst systems.

Applicant has unexpectedly and surprising discovered that the problems exhibited by prior systems can be overcome by utilizing a substantially reduced concentration of alkali metal salt in the catalyst system which is added to the other components of the premix composition. More particularly, for reasons that are at present not fully understood, the present invention overcomes the aforementioned disadvantages of the prior art by providing a catalyst system comprising a polar solvent and no greater than about 60% by weight based on the total weight of the catalyst solution, of an alkali metal salt, preferably a salt selected from the group consisting of lithium, potassium and sodium salts and combinations of two or more of these. Applicants have discovered unexpectedly that when the present catalyst systems are introduced into a composition containing low boiling point blowing agents relatively little or substantially no frothing results. The present invention therefore provides improved polyol premix compositions, improved foamabel compositions, improved foams, and improved methods of forming a foam by reacting the premix, preferably with an isocyanate, to produce a foam. Even more surprising, the advantages of the present invention exist even for embodiments which utilize a total amount of alkali metal salt, on the basis of the premix composition, that caused substantial and deleterious frothing in the prior art systems.

According to certain embodiments, the present invention provides methods of producing a foam premix composition comprising at least one reactive compound, blowing agent and a foaming catalyst. The methods comprise exposing the blowing agent to a catalyst system of the present invention to produce a premix composition for use in a foaming reaction. The present methods avoid the deleterious frothing associated with prior art methods. The present methods are particularly well adapted to and especially beneficial for use in the formation of premix compositions having a blowing agent comprising, and preferably comprising at least a major proportion of low boiling blowing agent. As used herein, the term “low boiling blowing agent” means a single component with a boiling point at atmospheric conditions of about 70? F (21.1? C) or less and for multi-component blowing agents, an initial boiling point of about 70? F (21.1? C) or less.

Any of a wide range of alkali metal salts, and preferably a sodium or potassium salt or combinations of these, are suitable for use in the catalyst solutions of the present invention. In general it is believed that any catalyst system which utilizes an alkali metal salt capable of catalyzing a polyurethane or polyisocyanurate foam reaction to form a polyurethane or polyisocyanurate foam is adaptable for use in accordance with the present invention. For embodiments which utilize potassium salt catalyst, preferred potassium salts include 2-ethyl hexanoic potassium salt (potassium octoate), potassium acetate, and combinations of two or more thereof. In certain embodiments, 2-ethyl hexanoic potassium salt is most preferred.

Any of a wide range of solvents may be used as a catalyst solvent according to the present invention. Suitable solvents generally are polar solvents, such as glycols, alcohols, water and the like. Among the glycols, particularly preferred are diglycols such as diethylene glycol, and dipropylene glycol. Combinations of two or more solvents may be used.

As noted above, the amounts of potassium salt and catalyst solvent for use in the present methods should be selected to provide a catalyst solution comprising no greater than about 55 wt % or less of alkali metal salt, more preferably no greater than about 50 wt %, and even more preferably no greater than about 45 wt % based on the total weight of the catalyst solution. It is contemplated that any amounts of potassium salt and catalyst solvent resulting in a solution within this range are suitable for use in the present invention. In certain preferred embodiments, the amounts of potassium salt and catalyst solvent are selected to provide a solution comprising from about 10 wt % to about 45 wt % or less of potassium salt based on the total weight of the catalyst solution. In certain more preferred embodiments, the amounts of potassium salt and catalyst solvent are selected to provide a solution comprising from about 20 wt % to about 45 wt %, more preferably from about 30 wt % to about 45 wt % of potassium salt based on the total weight of the catalyst solution, and even more preferably about 43 wt % of potassium salt.

The present invention also provides a substantially non-frothing premix composition, and substantially non-frothing foamable composition, comprising low boiling point blowing agent and catalyst in accordance with the present invention in an amount sufficient to produce a concentration of metal salt in the foamable or premix composition of from about 10 wt. % to about 30 wt. %. This aspect of the invention is surprising and counterintuitive since this loading of metal salt is in the same range that caused excessive frothing in prior art compositions. Thus, the present invention provides methods of providing pre-mix and foamable compositions comprising introducing a catalyst solution comprising no greater than about 55 wt % or less of alkali metal salt to low boiling point blowing agent under conditions effective to produce a premix or foamable composition having an alkali metal salt concentration of from about 10 wt. % to about 30 wt. %, and even more preferably from about 10 wt % to about 25 wt %.

Given the information contained herein, those skilled in the art will be able to utilze any suitable methods of producing polyurethane or polyisocyanurate foams known in the art, such as those described in “Polyurethanes Chemistry and Technology,” Volumes I and II, Saunders and Frisch, 1962, John Wiley and Sons, New York, N.Y., which is incorporated herein by reference, in connection with the catalyst systems and/or premixes of the present invention. In general, such preferred methods comprise preparing polyurethane or polyisocyanurate foams by combining an isocyanate, a polyol or mixture of polyols, blowing agent(s), a catalyst system of the present invention, and optionally other materials such as other catalysts, surfactants, flame retardants, colorants, and the like. It is convenient in many applications to provide the components for polyurethane or polyisocyanurate foams in pre-blended formulations which are commonly referred to as premixes. Most typically, the foam formulation is pre-blended into two parts. The isocyanate and optionally certain surfactants and blowing agents typically comprise the first component, commonly referred to as the “A” part. The polyol or polyol mixture, surfactant, catalysts, blowing agents, flame retardant, and other isocyanate reactive components typically comprise the second component, commonly referred to as the “B” part. Accordingly, polyurethane or polyisocyanurate foams are readily prepared by bringing together the A and B parts either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, and even other polyols can be added as a third stream to the mix head or reaction site. Most conveniently, however, they are all incorporated into one B-component as described above.

Any of a wide range of suitable blowing agents may be used in the methods of the present invention. Examples of suitable blowing agents include: hydrofluorocarbons, including difluoroethanes, such as 1,1-difluoroethane (“HFC-152a”), tetrafluoroethanes, such as 1,1,1,2-tetrafluoroethane (“HFC-134a”), pentafluoroethanes, such as 1,1,1,2,2-pentafluoroethane (“HFC-125”), pentafluoropropanes, such as 1,1,1,3,3-pentafluoropropane (“HFC-245fa”), pentafluorobutanes, such as 1,1,1,3,3-pentafluorobutane (“HFC-365mfc”), and the like, hydrochlorofluorocarbons, including chlorodifluoromethane (“HCFC-22”), 1-chloro-1,2,2,2-tetrafluoroethane (“HCFC-124”), 1-chloro-1,1-difluoroethane (“HCFC-142b”), and the like, hydrocarbons, including butane, n-pentane, isopentane, cyclopentane, n-hexane, isohexane, cyclohexane, heptanes, octanes, nonanes, decanes, and the like, water, and combinations of two or more of any of the above.

As mentioned above, applicant has come to recognize that, according to certain preferred embodiments, the benefits afforded by the methods of the present invention are of particular significance in systems comprising a blowing agent comprising at least one blowing agent material having a boiling point not greater than about 70? F (21.1? C), more preferably not greater than about 60? F, and even more preferably not greater than about 50? F. In certain preferred embodiments, the blowing agent comprises at least one blowing agent material having a boiling point from about 40? F (4.44? C) to about 70? F (21.1 ? C). Accordingly, in certain preferred embodiments, the methods of the present invention comprise reacting and foaming a mixture comprising a blowing agent comprising, or consisting of, a blowing agent material having a boiling point below about 70? F (21.1 ? C) in the presence of a catalyst system of the invention. In certain other preferred embodiments, the present invention comprises reacting and foaming a mixture comprising a blowing agent comprising, or consisting of, a blowing agent material having a boiling point between about 70? F (21.1? C) and about 40? F (4.44? C) and a blowing agent material having a boiling point below about 40? F (4.44? C), in the presence of a catalyst solution of the present invention. In light of the teachings herein, those of skill in the art will readily be able to select blowing agent materials for use according to the preferred embodiments of the present invention.

The methods of the present invention may further comprise dispersing agents, cell stabilizers, and surfactants that are also incorporated into the A or B-side mixtures. Surfactants, better known as silicone oils, are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458. Other optional additives for the mixtures may include flame retardants such as tri(2-chloroethyl)phosphate, tri(2-chloropropyl)phosphate, tri(2,3-dibromopropyl)-phosphate, tri(1,3-dichloropropyl)phosphate, diammonium phosphate, various halogenated aromatic compounds, antimony oxide, aluminum trihydrate, polyvinyl chloride, and the like.

### EXAMPLES

The present invention is further illustrated via the following examples. Such examples are not intended to be limiting in any manner. For the following examples:

Terate 2541 is a polyester polyol available from Kosa;

Tegostab B8462 is a surfactant available from Goldschmidt;

Polycat 8 is a catalyst available from Air Products;

Dabco K-15 is a catalyst solution of 75 wt % 2-ethylhexanoic potassium salt/25 wt % diethylene glycol available from Air Products; and

Lupranate M70L is an isocyanate material available from BASF.

### Examples 1-4

Four B-side mixtures (E1-E4) comprising a catalyst solution of the present invention, as well as, polyols, surfactants, other catalysts, and blowing agents in the amounts shown in Table 1 were prepared via mixing and then stored. The catalyst solution in these examples comprised diethylene glycol and about 43 wt % of 2-ethylhexanoic potassium salt. The catalyst solutions were prepared by diluting a sample of Dabco K-15 with diethylene glycol to obtain the desired weight percent solution.

The B-side mixtures were observed during mixing and storing to determine if any frothing occurred. An observation of “froth” or “no froth” is indicated in Table 1.

TABLE 1

| Component in | | | | |
|---|---|---|---|---|
| parts by | | | | |
| weight (pbw) | E1 | E2 | E3 | E4 |
| Terate 2541 | 100 | 100 | 100 | 100 |
| Tegostab | 2 | 2 | 2 | 2 |
| B8462 | | | | |
| Polycat 8 | 1.2 | 1.2 | 1.2 | 1.2 |
| Catalyst | 6 | 6 | 6 | 6 |
| solution | | | | |
| HCFC-124 | 50 | 33.3 | 28.5 | 0 |
| HCFC-141b | 0 | 14.3 | 16.7 | 43 |
| Observation | No froth | No froth | No froth | No froth |

### Comparative Examples 1-4

Four B-side mixtures (C1-C4) comprising conventional catalysts, as well as polyols, surfactants, and blowing agents in the amounts shown in Table 2 were prepared via mixing and then stored. The B-side mixtures were observed during mixing and storing to determine if any frothing occurred. An observation of “froth” or “no froth” is indicated in Table 2.

TABLE 2

| Component in | | | | |
|---|---|---|---|---|
| parts by | | | | |
| weight (pbw) | C1 | C2 | C3 | C4 |
| Terate 2541 | 100 | 100 | 100 | 100 |
| Tegostab | 2 | 2 | 2 | 2 |
| B8462 | | | | |
| Polycat 8 | 1.2 | 1.2 | 1.2 | 1.2 |
| Dabco K-15 | 3 | 3 | 3 | 3 |
| HCFC-124 | 50 | 33.3 | 28.5 | 0 |
| HCFC-141b | 0 | 14.3 | 16.7 | 43 |
| Observation | Froth | Froth | Froth | No froth |

### Examples 5-8

Four B-side mixtures (E5-E8) comprising a catalyst solution of the present invention, as well as, polyols, surfactants, other catalysts, and blowing agents in the amounts shown in Table 3 were prepared via mixing and then stored. The catalyst solution in these examples comprised diethylene glycol and about 43 wt % of 2-ethylhexanoic potassium salt. The catalyst solutions were prepared by diluting a sample of Dabco K-15 with diethylene glycol to obtain the desired weight percent solution.

The B-side mixtures were observed during mixing and storing to determine if any frothing occurred. An observation of “froth” or “no froth” is indicated in Table 3.

TABLE 3

| Component in | | | | |
|---|---|---|---|---|
| parts by | | | | |
| weight (pbw) | E5 | E6 | E7 | E8 |
| Terate 2541 | 100 | 100 | 100 | 100 |
| Tegostab | 2 | 2 | 2 | 2 |
| B8462 | | | | |
| Polycat 8 | 1.3 | 1.3 | 1.3 | 1.3 |
| Catalyst | 5.8 | 5.8 | 5.8 | 5.8 |
| solution | | | | |
| Water | 1 | 1 | 1 | 1 |
| HCFC-124 | 44 | 29.50 | 14.5 | 0 |
| HFC-245fa | 0 | 12.4 | 25.3 | 37.7 |
| Observation | No froth | No froth | No froth | No froth |

### Comparative Example 5

A B-side mixture comprising: 100 pbw Terate 2541, 2 pbw Tegostab B8462, 1.3 pbw Polycat 8, 2.9 pbw Dabco K-15, 1 pbw water, and 37.7 pbw HFC-245fa was prepared via mixing and then stored. The mixture was observed, as in above examples, during mixing and storing to determine if any frothing occurred. No frothing was observed.

### Examples 9-12

Four B-side mixtures (E9-E 12) comprising a catalyst solution of the present invention, as well as, polyols, surfactants, other catalysts, and blowing agents in the amounts shown in Table 4 were prepared via mixing and then stored. The catalyst solution in these examples comprised diethylene glycol and about 43 wt % of 2-ethylhexanoic potassium salt. The catalyst solutions were prepared by diluting a sample of Dabco K-15 with diethylene glycol to obtain the desired weight percent solution.

The B-side mixtures were observed during mixing and storing to determine if any frothing occurred. An observation of “froth” or “no froth” is indicated in Table 4. The B-side mixtures were then mixed and reacted with an A-side comprising Lupranate M70L isocyanate material to form a foam.

TABLE 4

| Component in | | | | |
|---|---|---|---|---|
| parts by | | | | |
| weight (pbw) | E9 | E10 | E11 | E12 |
| Terate 2541 | 100 | 100 | 100 | 100 |
| Tegostab | 2 | 2 | 2 | 2 |
| B8462 | | | | |
| Polycat 8 | 1.2 | 1.2 | 1.2 | 1.2 |
| Catalyst | 5.8 | 5.8 | 5.8 | 5.8 |
| solution | | | | |
| HCFC-124 | 50 | 33.5 | 16.5 | 0 |
| Hexane | 0 | 10.4 | 21.1 | 31.5 |
| Lupranate | 173.1 | 173.1 | 293.2 | 173.1 |
| M70L | | | | |
| Observation | No froth | No froth | No froth | No froth |

### Comparative Example 6

A B-side mixture comprising: 100 pbw Terate 2541, 2 pbw Tegostab B8462, 1.2 pbw Polycat 8, 2.9 pbw Dabco K-15, 31.5 pbw hexane, and 173.1 pbw Lupranate M70L was prepared via mixing and then stored. The mixture was observed, as in above examples, during mixing and storing to determine if any frothing occurred. No frothing was observed. The B-side mixture was then mixed and reacted with an A-side comprising Lupranate M70L isocyanate material to form a foam.

What is claimed is:

1. A foam catalyst system comprising an alkali metal salt foam catalyst in a carrier for said catalyst, said alkali metal salt being present in the catalyst system in an amount not greater than about 60% by weight based on the combined weight of said salt and said carrier.

2. The system of claim 1 wherein said carrier is a solvent for said alkali metal salt.

3. The system of claim 1 wherein said alkali metal salt comprises potassium salt.

4. The system of claim 3 wherein said alkali metal salt is selected from the group consists of lithium salt, potassium salt, sodium salt and combinations of two or more of these.

5. The system of claim 4 wherein said alkali metal salt consists essentially of potassium salt.

6. The system of claim 5 wherein said alkali metal salt consists of potassium salt.

7. A foam premix composition comprising at least one foaming reactant, a blowing agent, and a catalyst system comprising alkali metal salt catalyst and a carrier for said catalyst, said alkali metal salt being present in the catalyst system in an amount not greater than about 50% by weight based on the combined weight of said salt and said carrier, said catalyst being present in the premix compositon in an amount sufficient to provide said premix composition with an alkali metal salt concentration of from about 10 wt. % to about 30 wt. %

8. A method of producing a polyurethane or polyisocyanurate foam comprising (a) forming a premix composition comprising a catalyst system, at least one reactive agent and at least one blowing agent, said catalyst system comprising a carrier and an alkali metal salt in an amount not greater than about 60% by weight based on the combined weight of said salt and said carrier; (b) including said premix composition in a foamable reactive mixture; and (c) foaming said reactive mixture to form a polyurethane or polyisocyanurate foam.

9. The method of claim 8 wherein said catalyst system comprises no greater about 45 wt % of said potassium salt.

10. The method of claim 9 wherein said catalyst system comprises from about 10 wt % to about 45 wt % of said potassium salt.

11. The method of claim 10 wherein said catalyst comprises about 43 wt % of said potassium salt.

12. The method of claim 11 wherein said potassium salt is selected from the group consisting of 2-ethyl hexanoic potassium salt, potassium acetate, and combinations of two or more thereof.

13. The method of claim 12 wherein said potassium salt comprises 2-ethyl hexanoic potassium salt.

14. The method of claim 8 wherein said carrier is a polar catalyst solvent.

15. The method of claim 14 wherein said polar catalyst solvent comprises at least one diglycol.

16. The method of claim 15 wherein said diglycol is selected from the group consisting of diethylene glycol, dipropylene glycol and combinations of two or more thereof.

17. The method of claim 16 wherein said solvent comprises diethylene glycol.

18. The method of claim 17 wherein said solvent comprises dipropylene glycol.

19. The method of claim 8 wherein said at least one blowing agent comprises at least one hydrocarbon, HFC or HCFC having a boiling point of less than about 70° F. (21.1° C.) at 1 atm.

20. The method of claim 19 wherein said at least one blowing agent is selected from the group consisting of R-141b, R-245fa, n-pentane, isopentane, cyclopentane, n-hexane, isohexane, cyclohexane, and combinations of two or more thereof.

21. The method of claim 20 wherein said at least one blowing agent is selected from the group consisting of R-22, R-124, R-134a, R-152a, R-142b, R-125, and combinations of two or more thereof.

22. A polyurethane or polyisocyanurate foam formed via the method of claim 8.

23. A polyol premix comprising a polyol and a catalyst solution comprising a catalyst solvent and no greater than about 30 wt %, based on the total weight of the catalyst solution, of potassium salt.

24. A foam premix composition comprising at least one foaming reactant, a blowing agent, and a catalyst system comprising alkali metal salt catalyst and a carrier for said catalyst, said alkali metal salt being present in the catalyst system in an amount not greater than about 50% by weight based on the combined weight of said salt and said carrier.

25. A method of producing a foamable comprising (a) providing a catalyst system comprising a carrier and an alkali metal salt in an amount not greater than about 60% by weight based on the combined weight of said salt and said carrier; (b) introducing said catalyst system to a low boiling point blowing agent; (c) including said catalyst system and said blowing agent in a reactive mixture to produce a foamable compositon comprising from about 10 wt % to about 30% by weight of said alkali metal salt.

26. A method of forming a foam comprising foaming the foamable composition of claim 25.
